(19) United States
(12) Patent Application Publication
(10) Pub. No.: US 2007/0236215 A1
(43) Pub. Date: Oct. 11, 2007

(54) System and Method for Obtaining Well Fluid Samples

(75) Inventors: Martin Innes, Aberdeen (GB); David MacWilliam, Aberdeenshire (GB); Javed Shafi, Aberdeen (GB); Jonathan W. Brown, Sugar Land, TX (US)

Correspondence Address: SCHLUMBERGER TECHNOLOGY CORPORATION, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/307,320

(22) Filed: Feb. 1, 2006

(51) Int. Cl. G01V 3/18

(52) U.S. Cl. 324/303

(57) ABSTRACT

A system and method facilitates the sampling of well fluid during a well logging operation. A sampling tool may be coupled into a logging tool string and delivered downhole into a wellbore. At a desired location within the wellbore, the sampling tool may be triggered to intake a well fluid sample. The well fluid sample is maintained in the sampling tool in a substantially pristine condition for retrieval to a desired location for analysis.

### BACKGROUND OF THE INVENTION

1. Field of the Invention

The present invention generally relates to a system and methodology for sampling well fluids. A wellbore is drilled into a formation containing fluids, and a sampling tool is used to obtain a fluid sample for evaluation.

2. Description of Related Art

During various phases of the life of a well, several characteristics of produced fluid can be logged. Logging tools are used to evaluate single or multi-phase flow in both producing wells and injection wells. The logging tool string often comprises several specific sensors for measuring each of the desired parameters, e.g. fluid velocity, pressure, and temperature. Logging tools are of relatively complex design requiring surface read-out and data acquisition. Additionally, the design must accommodate internal electronics as well as through-wiring to enable connection with other modules above and below a given logging tool.

In addition to the logging data obtained with respect to flowing fluid, the collection of representative reservoir fluid samples for Pressure, Volume, Temperature (PVT) analysis can further optimize future production from a reservoir. The collection of well fluid samples during logging processes is, however, difficult. The sampling tool must capture a pressurized fluid sample and return that pressurized sample to the surface for analysis in substantially pristine condition. Although many sampling tools have been designed that can be run in a logging string, these have resulted in relatively expensive and complex devices that can be unwieldy to use in a production environment. Such sampling tools rely on triggering by timer and cannot be selectively triggered from the surface. Additionally, these sampling tools must be installed at the bottom of the logging string, which effectively precludes the use of a flow caliper which must itself be located at the bottom of the logging string. Hence, there is a need for a sampling tool that can be selectively triggered from the surface and can be installed in any position in the logging string.

### BRIEF SUMMARY OF THE INVENTION

In general, the present invention provides a system and methodology that facilitates the sampling of well fluids during logging processes. A sampling tool can be coupled into a logging string in any position for movement to a downhole location. The sampling tool comprises a housing having an internal sample chamber and a device that can be selectively triggered from the surface to draw a well fluid sample into the sample chamber. The sampling tool and contained well fluid sample can then be withdrawn from the well to enable analysis of the well fluid sample.

### BRIEF DESCRIPTION OF THE DRAWINGS

Certain embodiments of the invention will hereafter be described with reference to the accompanying drawings, wherein like reference numerals denote like elements, and:

FIG. 1 is a front elevation view of a logging system deployed in a wellbore, according to an embodiment of the present invention;

FIG. 2 is a schematic illustration of a sampling tool structure that can be utilized in the logging system illustrated in FIG. 1, according to an embodiment of the present invention;

FIG. 3 is a more detailed schematic illustration of a sampling tool, according to an embodiment of the present invention;

FIG. 4 is a schematic illustration of an alternate embodiment of the sampling tool illustrated in FIG. 3;

FIG. 5 is a schematic illustration of an alternate embodiment of the sampling tool illustrated in FIG. 3;

FIG. 6 is a schematic illustration of an alternate embodiment of the sampling tool illustrated in FIG. 3; and

FIG. 7 is a schematic illustration of a sampling tool combined with an agitation and heating system, according to an embodiment of the present invention.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a system and methodology for taking a representative sample of fluid from a reservoir, such as representative fluid samples of oil and/or gas from an oil well. A sampling tool is utilized with a logging tool string to facilitate the collection of, for example, PVT samples while the sampling tool is selectively coupled within the logging string. The sampling tool also can be constructed with a bypass to accommodate communication lines, such as electric lines or fiber optic lines, for communication with equipment positioned above or below the sampling tool. This capability also facilitates the placement of the sampling tool in any of a variety of positions along the logging string. Furthermore, the sampling tool can be prepared at a central facility, shipped to a wellsite, coupled into a tool string, run downhole for retrieval of a well fluid sample, retrieved from the wellbore, removed from the logging tool string, and shipped to a sample analysis facility without transference of the well fluid sample. This greatly facilitates the ability to maintain sample quality.

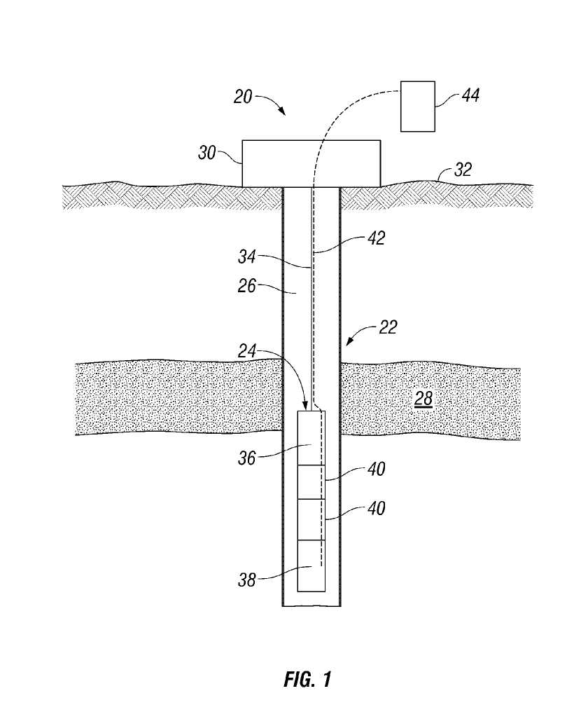

The system and method can be utilized with a variety of downhole logging systems. One example is illustrated in FIG. 1 and comprises a logging system 20 for use in evaluating well characteristics, such as flow characteristics, in a well 22. Logging system 20 generally comprises a logging tool string 24 disposed in a wellbore 26 which is drilled or otherwise formed in a subterranean reservoir or formation 28. Wellbore 26 may be an open wellbore or a cased wellbore. The logging tool string 24 is suspended below a wellhead 30 located, for example, at a surface 32 of the earth. Logging tool string 24 is suspended by a deployment system 34, such as a wireline, tubing, or a drill string.

In the embodiment illustrated, logging tool string 24 comprises a plurality of logging tools or modules, e.g. modules 36 and 38. Modules 36 and 38 may include equipment used in sensing various well parameters, such as flowing characteristics of a produced fluid as it flows up through wellbore 26. One or more sampling tools 40 are removably coupled into the logging string 24 between modules 36 and 38. In the specific example illustrated, two sampling tools 40 are illustrated, although a variety of sampling tools can be used at various locations along the logging string. For example, several sampling devices 40 can be mounted in series and selectively actuated at different times to obtain unique fluid samples.

Each sampling tool 40 is coupled in line with other components of logging tool string 24 by, for example, conventional mechanisms used for connecting logging string components in series, as known to those of ordinary skill in the art. Furthermore, each sampling tool 40 may be formed with an outside diameter no greater than the outside diameter of the logging string components, e.g. logging string modules 36 and 38. The limited outside diameter facilitates the use of one or more sampling tools at various locations along the logging tool string without providing any expanded regions that can otherwise interfere with insertion and removal of the logging tool string from the wellbore.

Logging system 20 further comprises one or more communication lines 42 to communicate signals between a surface control 44 and sampling tools 40 and/or other logging string modules. The communication lines 42 also can be used to enable communication between a sampling tool 40 and a module above the sampling tool, e.g. module 36; between sampling tool 40 and a module below the sampling tool, e.g. module 38; or between modules positioned on opposite ends of the sampling tool 40. The communication line or lines 42 can be used to transmit a variety of signals, including electrical signals, optical signals, or other types of signals usable for communication downhole. With wired systems, such as those utilizing electrical or fiber optic lines, each sampling tool 40 may comprise a bypass through which the communication lines extend within the sampling tool.

Sampling tools 40 are designed to take well fluid samples from subsurface reservoirs to facilitate the reservoir evaluation process. Fluid within wellbore 26 is moved into a specific sampling tool 40 and contained therein in substantially pristine condition. The well fluid sample is maintained as the sampling tool 40 is retrieved to a specific location for analysis. For example, logging system 20 may be withdrawn by deployment system 34, and each sampling tool 40 can be decoupled, i.e. removed, from the logging tool string 24. Each sampling tool 40 also can be constructed to enable the safe and legal transportation of the sampling tool 40 while the pressurized fluid sample remains contained within the tool. This ability to transport the well fluid sample within the sampling tool ensures that the sample remains in pristine condition until the sample can be analyzed in, for example, a PVT laboratory. Maintaining the well fluid sample within the sampling tool 40 also eliminates the need for additional operating/handling equipment at the well site, thereby saving considerable cost. Furthermore, each sampling tool 40 can be designed to restore the well fluid sample back to bottomhole conditions before the sample is transferred from the device, as explained in greater detail below.

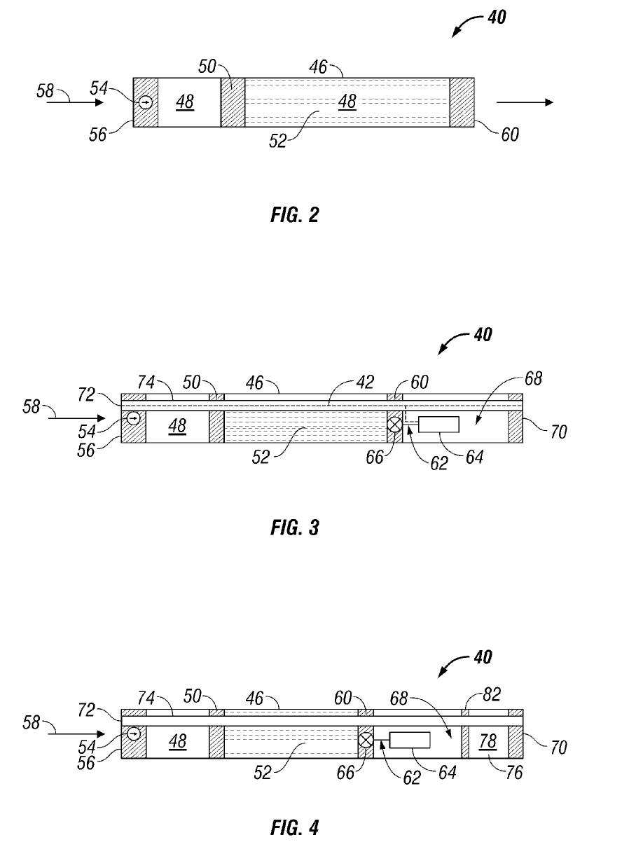

Referring to FIG. 2, a generalized example of one of the sampling tools 40 is illustrated. The sampling tool 40 comprises a housing 46 having an internal sample chamber 48. A movable member 50 is movably disposed within sample chamber 48 and separates a buffer fluid 52 from a well fluid sample that may be drawn into sample chamber 48. By way of example, movable member 50 may comprise a floating piston sealingly and slidably mounted within sample chamber 48. When sampling tool 40 is deployed at a desired location within wellbore 26, a well fluid sample is drawn into sample chamber 48 through, for example, a valve 54 by creating a pressure differential. In this embodiment, sampling tool 40 comprises a sample intake structure 56, such as an end cap, through which the well fluid sample is drawn via the pressure differential between the high external wellbore pressure and the lower internal pressure within sample chamber 48. Intake of the well fluid sample into sample chamber 48 is indicated by arrow 58.

The pressure differential can be created by utilizing sample chamber 48 as an atmospheric chamber containing a compressible fluid selectively isolated from the higher surrounding wellbore pressure by, for example, valve 54. When the valve is opened, the pressure differential causes the well fluid sample to flow into sample chamber 48. In other applications, as discussed in greater detail below, buffer fluid 52 comprises a substantially incompressible fluid, such as a hydraulic fluid, that may be selectively expelled from sample chamber 48 through a discharge structure 60. For example, a simple inexpensive trigger device 62 can be coupled to discharge structure 60 to control the exit of buffer fluid 52. The exiting of buffer fluid 52 creates a differential pressure that draws movable member 50 through sample chamber 48 and causes the well fluid sample to enter sample chamber 48 on a side of movable member 50 opposite the buffer fluid.

One embodiment of a trigger device 62 is illustrated in FIG. 3. In this embodiment, trigger device 62 comprises an electrically actuated device 64 coupled to a valve 66 disposed in discharge structure 60. By way of example, electrically actuated device 64 may comprise a solenoid or an electric motor coupled to valve 66 by a lead screw for actuation of the valve 66. Electrically actuated device 64 is enclosed by housing 46 within an atmospheric or low-pressure chamber 68. When electrically actuated device 64 is powered, the valve 66 is actuated to a desired open position which allows buffer fluid 52 to flow from sample chamber 48 through discharge structure 60 and into low pressure chamber 68 at a desired rate. Low pressure chamber 68 may be sealed by an end cap 70 to securely maintain both the buffer fluid 52 and the well fluid sample within sampling tool 40. As the buffer fluid 52 flows from sample chamber 48 into low pressure chamber 68, movable member 50 is drawn through sample chamber 48 and the resulting pressure differential between the sample chamber 48 and the surrounding wellbore environment draws the well fluid sample into sample chamber 48 through intake structure 56.

In this embodiment, an internal bypass 72 is provided for conducting communication line or lines 42 through the sampling tool 40. As illustrated, the internal bypass 72 may be formed with a conduit 74 extending longitudinally along or through housing 46. The internal bypass 72 enables communication between modules in the logging tool string above and below sampling tool 40, between surface control 44 and modules below sampling tool 40, and/or between the sampling tool 40 and other modules in the logging tool string 24.

For example, the internal bypass 72 and communication lines 42 can be used to selectively operate electrically actuated device 64 with signals provided from surface control 44. Effectively, operation of the electrically actuated device 64, e.g. an electric motor, can act as a trigger to initiate sampling and/or to control the flow rate of buffer fluid 52 from sample chamber 48 into low pressure chamber 68. However, operation of the electrically actuated device 64 also can be initiated according to logic contained within sampling tool 40. Furthermore, trigger device 62 can be powered from the surface, or the power source can be a local source, such as an internal battery.

A further embodiment of sampling tool 40 is illustrated in FIG. 4. In this embodiment, sampling tool 40 comprises a contained energy source 76 to facilitate recovery of the well fluid sample at or above reservoir pressure. For example, the well fluid sample can be restored to reservoir pressure to enhance the analysis of the well fluid sample at a surface location. The pressurization is accomplished by using the energy source 76 to move the displaced buffer fluid 52 back into the sample chamber 48 against the movable member or floating piston 50 which, in turn, is moved against the reservoir fluid sample to increase the pressure of the fluid sample. By way of example, energy source 76 may comprise an extra chamber 78 designed to hold a compressed fluid, such as compressed nitrogen, within sampling tool housing 46. The compressed nitrogen acts as a spring against buffer fluid 52 and thus against floating piston 50, thereby compressing the sample fluid. A floating piston or other structure 82 can be used between the compressed nitrogen and the buffer fluid 52, similar to the use of movable member 50. Furthermore, the compressed nitrogen can be released by a variety of known mechanisms, including manually or automatically actuated valves. The pressure compensation also can be used to compensate for thermal contraction of the well fluid sample as it exits the wellbore. Furthermore, valve 66 or an additional valve can be designed to provide pressure relief if the pressure buildup with respect to the internal buffer fluid increases above a predetermined threshold due to, for example, thermal effects on the buffer fluid 52.

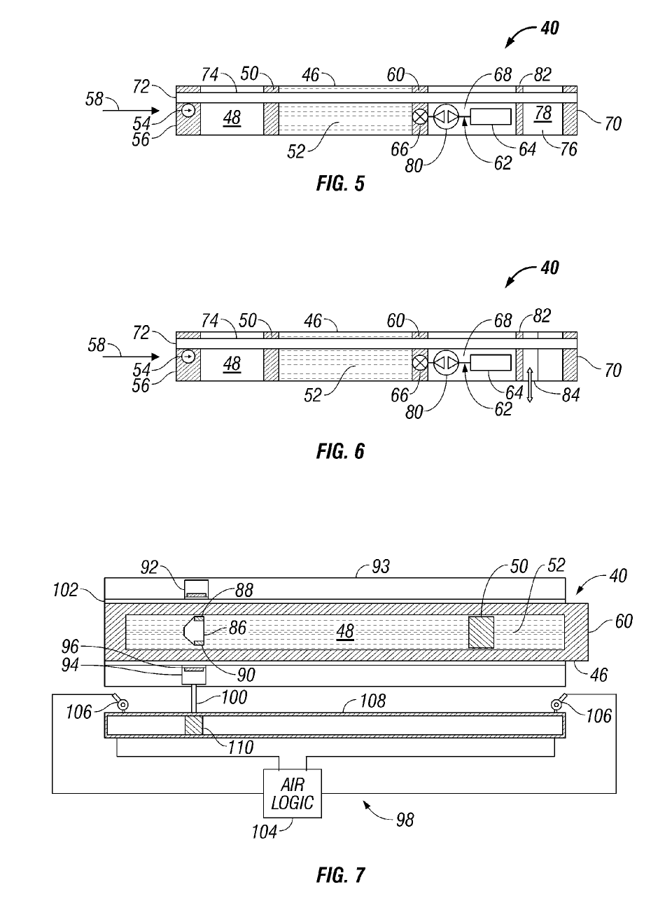

Referring generally to FIG. 5, another embodiment of sampling tool 40 is illustrated. In this embodiment, triggering of the well fluid sample intake is accomplished by creating a pressure differential with a pump 80 located within housing 46. In this embodiment, electrically actuated device 64 comprises a motor coupled to pump 80 to selectively operate the pump 80 for withdrawing buffer fluid 52 from sample chamber 48 through valve 66 of discharge structure 60. The pump 80 and motor 64 operate within clean buffer fluid, such as clean hydraulic oil, which enables the use of simple inexpensive pump and motor components, e.g. a simple rotary axial piston pump, screw pump, or gear pump.

In this embodiment, the sampling operation is initiated by starting the motor 64 via control signals originated from the surface or locally within sampling tool 40. As a motor 64 powers pump 80, fluid is pumped from sample chamber 48 into low pressure chamber 68. The pump 80 can be positioned to pump buffer fluid 52, e.g. hydraulic oil, past the motor to help cool motor 64. Alternatively, however, pump 80 can be used to transport the buffer fluid 52 out into the surrounding wellbore rather than into low pressure chamber 68. This latter embodiment eliminates the need for a low pressure chamber which further reduces the complexity and length of the sampling tool 40. Furthermore, when the buffer fluid 52 is pumped to the surrounding wellbore, the trigger device 62, comprising pump 80 and motor 64, can be pressure balanced to the surrounding wellbore pressure to minimize pressure differentials.

The pump 80 can also be used to pressurize the well fluid sample by pumping buffer fluid 52 back into sample chamber 48 and against movable member 50. The pump 80 can be used alone or in combination with energy source 76 to reduce the effort of the pump 80. For example, energy source 76 can be used to substantially pressurize the well fluid sample, and pump 80 can be used to make further adjustments to the pressurization.

The action of pump 80 in pressurizing the well fluid sample can also be minimized by utilizing the external pressure found in the surrounding wellbore, as illustrated in FIG. 6. In this embodiment, the buffer fluid 52 is segregated from the wellbore by piston 82 exposed to low pressure chamber 68 and buffer fluid 52 on one side while being exposed to wellbore pressure on the opposite side. The exposure to wellbore pressure is provided by a port 84 through housing 46. The wellbore pressure effectively acts as an energy source to help force buffer fluid back into sample chamber 48 and against movable member 50 to pressurize the well fluid sample. Pump 80 can be operated to further adjust the pressure of the buffer fluid 52 acting on the well fluid sample.

In an alternate embodiment, sampling tool 40 comprises components to facilitate restoration of the sample back to bottomhole conditions, such as bottomhole temperature, pressure, and phase conditions. The restoration can be facilitated by deploying an agitation member 86 in the sample chamber 48, as illustrated in FIG. 7. Agitation member 86 is a movable member that may be a magnetic agitation member having magnets 88. For example, the agitation member 86 may be formed with a ring 90 to which magnets 88 are attached, wherein the ring 90 is able to undergo reciprocating or rotating motion within sample chamber 48.

Movement of agitation member 86 is driven by an external driving mechanism 92 when sampling tool 40 is mounted in a sampling tool mounting structure 93. By way of example, driving mechanism 92 may comprise a driving ring 94 having driving magnets 96 attached thereto. The driving magnets 96 are arranged so that the poles attract and locate the magnets 88 of internal agitation member 86, such that the poles of the driving magnets 96 move the agitation member 86 by repulsion forces.

Driving mechanism 92 is coupled to a power unit 98 by a drive link 100. In this embodiment, power unit 98 moves the agitation member 86 in a reciprocating motion through sample chamber 48 to facilitate mixing of the well fluid sample contained within sample chamber 48. Additionally, a heating element 102 may be incorporated into the design to reestablish desired temperatures of the well fluid sample within sample chamber 48. By way of example, the heating element 102 may comprise a thin etched foil element disposed about sampling tool 40 when sampling tool 40 is mounted in mounting structure 93 of the agitation device. The heating element 102 may be placed between driving ring 94 and sampling tool 40 to enable simultaneous heating and agitation of the well fluid sample. Additionally, the heating element 102 may incorporate an integral sensor or similar trace heating system to facilitate control over the heat applied to the well fluid sample.

Power unit 98 can be designed to utilize an electric motor for moving drive link 100 via a belt drive or a chain drive. Alternatively, a stepper motor, controlled to limit travel length, is used to move drive link 100. In another alternative, the reciprocal movement is accomplished with a simple air logic control system 104 utilizing limit switches 106 which are signaled to reverse the air supplied to an elongated air chamber 108. Within the elongated air chamber 108, a piston member 110 is driven back and forth by the reversing of air supplied to chamber 108. The piston member 110 is coupled to driving ring 94 by drive link 100 to cause reciprocal motion of driving ring 94, thereby driving agitation member 86 in a reciprocating motion within sample chamber 48.

Accordingly, although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A system for sampling a wellbore fluid, comprising:
a logging string for deployment in a wellbore; and
a sampling tool coupled to the logging string, the sampling tool having a sample chamber and a movable member in the sample chamber to separate a buffer fluid from a sample fluid, wherein withdrawing the buffer fluid creates a pressure differential which causes movement of the movable member and intake of the sample fluid into the sample chamber.

2. The system as recited in claim 1, wherein the movable member comprises a floating piston in the sample chamber.

3. The system as recited in claim 1, wherein the sampling tool comprises a longitudinal conduit through which communication lines are run to a module beneath the sampling tool.

4. The system as recited in claim 1, wherein the sampling tool further comprises a valve that may be actuated for withdrawal of the buffer fluid.

5. The system as recited in claim 1, wherein the sampling tool further comprises a pump that may be actuated for withdrawal of the buffer fluid.

6. The system as recited in claim 1, wherein the sampling tool comprises an internal motor used to initiate sampling.

7. The system as recited in claim 1, wherein the sampling tool comprises an internal solenoid used to initiate sampling.

8. The system as recited in claim 1, wherein the sampling tool comprises a pressure compensation system to reestablish reservoir pressure after removal of the sampling tool from the well.

9. The system as recited in claim 1, further comprising a magnetically driven agitator disposed within the sample chamber.

10. An apparatus for use in a wellbore, comprising:
a sampling tool having a housing forming a sample chamber to hold a buffer fluid, the housing enclosing an electrically powered device to selectively remove the buffer fluid, the removal of buffer fluid creating a pressure differential that draws a well fluid sample into the sample chamber.

11. The apparatus as recited in claim 10, wherein the sampling tool comprises a conduit for communication lines extending through the sampling tool.

12. The apparatus as recited in claim 10, further comprising a valve actuated by the electrically powered device.

13. The apparatus as recited in claim 10, further comprising a pump actuated by the electrically powered device.

14. The apparatus as recited in claim 10, wherein the sampling tool is coupleable to a logging string having a diameter matching a diameter of the housing of the sampling tool.

15. The apparatus as recited in claim 10, further comprising an energy source within the housing to pressurize the well fluid sample to reservoir pressure after removal of the sampling tool from the wellbore.

16. The apparatus as recited in claim 10, further comprising a magnetically driven agitator disposed within the sample chamber.

17. A method of sampling a well fluid from a subterranean reservoir, comprising:
coupling a sampling tool to a logging string;
running the logging string downhole;
drawing a well fluid sample into the sample tool by removing a buffer fluid from the sample tool with a trigger device; and
maintaining the well fluid sample in the sampling tool as the sampling tool is returned to a surface location.

18. The method as recited in claim 17, further comprising forming the sampling tool with a diameter no greater than the diameter of the logging string.

19. The method as recited in claim 17, further comprising providing wired communication through the sampling tool.

20. The method as recited in claim 17, further comprising triggering the trigger device from a surface location to draw the well fluid sample into the sampling tool.

21. The method as recited in claim 17, further comprising forming the trigger device as an internal motor coupled to a valve.

22. The method as recited in claim 17, further comprising forming the trigger device as an internal solenoid coupled to a valve.

23. The method as recited in claim 17, further comprising forming the trigger device as an internal motor coupled to a pump.

24. The method as recited in claim 17, further comprising agitating the well fluid sample and returning the well fluid sample to its reservoir pressure when at the surface location.

25. A system, comprising:
a sampling tool having a housing with an internal sample chamber to obtain a well fluid sample when the sample tool is positioned in a wellbore, the sampling tool further having a magnetic agitation member disposed within the internal sample chamber.

26. The system as recited in claim 25, further comprising an agitation device to which the sampling tool may be mounted for agitation of the well fluid sample, the agitation device having at least one magnet mounted for reciprocating motion to move the magnetic agitation member in a corresponding reciprocating motion within the internal sample chamber.

27. The system as recited in claim 26, further comprising a heating element positioned along the agitation device to selectively heat the well fluid sample.
